(19) United States
(12) Patent Application Publication
(10) Pub. No.: US 2004/0179362 A1
(43) Pub. Date: Sep. 16, 2004

(54) Method and kit for game hunters to track wounded game at night using ultraviolet light

(76) Inventor: David Michael Klatt, Albany, GA (US)

Correspondence Address: DAVID M. KLATT, 116 TOCASTE LANE, ALBANY, GA, 31707, US

(21) Appl. No.: 10/384,951

(22) Filed: Mar. 10, 2003

(51) Int. Cl. F21V 33/00

(52) U.S. Cl. 362/253

(57) ABSTRACT

A method and kit for game hunters to track the blood trail of wounded game at night using an ultraviolet light comprising (i) a portable electric powered light that emits a beam of light in a distinct ultraviolet electromagnetic wavelength range and (ii) eyeglasses with colored lenses to look through to dampen glare and reflection of the ultraviolet light off the terrain. The method comprises of shining the ultraviolet light and lluminating the terrain area suspected of having blood. The blood that is present will absorb the blue ultraviolet light and turn darker making it easier for a hunter to follow the blood trail left by the wounded animal so that it may be recovered.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invention relates to a method for game hunters to track and locate wounded animals at night or in low light conditions by making use of the unique wavelength of blood under which the blood will darken to enhance its contrast by approximately 4 times when subjected to blue ultraviolet light. Eyeglasses with amber colored lenses are provided as an option for the game hunter to look through to minimize the glare or reflection of the blue ultraviolet light, but not needed for the phenomenon of light absorption to take place.

Darkness poses a problem for game hunters trying to recover a wounded animal by tracking their blood trail. Blood is very difficult to see at best at night on the woodland floor with traditional methods. Game is more active just before dark giving the hunter an opportunity to harvest the animal. Depending on shot placement, a blood trail is usually left by the fleeing animal, if not killed on the spot, and must be followed to recover the game. When shot at dusk, it is usually dark by the time the hunter can start tracking. Many animals are lost due to the inability of the hunter to track its blood trail.

The traditional method of tracking wounded game at night with white lights is very difficult and futile at best due to the way the blood is usually scattered and the varying ground cover and colors. The blood will blend in and be undistinguishable at night using an ordinary white light. Another method available to game hunters is a chemical based solution that must be mixed prior to using and then sprayed directly on the blood for luminescence. The quantity needed to properly track and recover the game is an unknown and could be a vast amount. The chance of covering the blood with the chemical when spraying, not knowing where the blood is, is also futile at best. Hunters have long needed a method to easily see a blood trail in the dark or low light conditions left by wounded game so that it may be recovered.

It is in the scope of this invention to provide a method of tracking wounded game at night, which is at least different from those that have hitherto been provided, and therefore provide a useful alternative for those wishing to purchase such units.

### BRIEF SUMMARY OF THE INVENTION

The object of this invention is to propose a method and kit for tracking wounded game at night or in low light conditions by a method using a blue ultraviolet light not applied to hunting. Although ultraviolet light has been used for blood detection in various arts, such arts are distantly related to the present invention.

Game hunters have either used a white light or chemicals to track wounded game at night. A blue ultraviolet light is an improvement over traditional fore mentioned methods used in the art today by making use of bloods unique wavelength to absorb blue ultraviolet light. The fore mentioned blue ultraviolet light would allow blood to appear 4 times darker and easier to see at night contrasted against the background of the terrain. The present invention would make a blood trail at night or in low light conditions much easier to see and follow than traditional methods.

The kit for game hunters to track wounded game at night consists of (i) a portable electric blue ultraviolet light and (ii) eyeglasses with amber colored lens to look through to dampen the glare and reflection of the fore mentioned blue ultraviolet light.

### DETAILED DESCRIPTION OF THE INVENTION

The present invention allows the game hunter to easily carry with her or him the blue ultraviolet light along with the colored lens eyeglasses while hunting. Together they are small and light enough to carry in pocket, on side, or in backpack. After a shot has been taken on game, it is a good idea for hunters to wait for game to bleed down and die. If game is shot at or near dusk it will be very low light or dark before hunter can begin a search for the animal. The hunter then can walk over to the spot where the animal was standing when shot was taken. If the game ran off due to increased adrenaline when shot, the hunter must search for the animal. The method of the present invention comprises of the hunter putting on the eyeglasses if desired, and shine or illuminate the ground area with the blue ultraviolet light to locate any blood left by the fleeing animal. To some eyesight the colored lens eyeglasses may be of help or a hindrance. It is solely up to individual preference. By using the present invention method with or without the amber colored eyeglasses, the blood will appear black and much darker than the surrounding background of the terrain due to the unique wavelength of blood that absorbs blue ultraviolet light. The game hunter then can begin to easily follow the blood trail left by the wounded animal and recover it. Many times wounded animals are lost and not recovered using traditional methods of tracking blood trails at night.

the present invention method to track wounded game at night uses a portable direct current battery powered blue ultraviolet light in the range of 435 to 500 nanometers. 470 nanometers is the preferred wavelength but not limited to.

how the ultraviolet light is created is not a function of the present invention but its use of is. Blue ultraviolet light may be created by emitting a white light through a blue lens or by one or more electrically powered blue LED's (light emitting diodes).

the preferred method of the present invention is using electrically powered blue LED's with an electromagnetic wavelength at or around 470 nanometers.

the fore mentioned light used by the present invention is one or more blue Light Emitting Diodes connected to a direct current power source (batteries) with an on/off power switch mounted in a housing the same as a traditional portable white bulb handheld flashlight.

the fore mentioned light used by the present invention can be a traditional portable white bulb or white LED flashlight with a blue lens, but not preferred for the following reasons; (i) Light Emitting Diodes are much brighter and have longer life than the traditional white light bulbs and (ii) the blue lens (filter) is not perfect. The blue lens will let through all of their own color, as well as some of the neighboring colors in the spectrum.

the fore mentioned blue LED flashlight used by the present invention is currently manufactured and marketed small and light enough to be handheld, worn on forehead as headlamp with strap, or clipped on the brim of a baseball cap for hands free operation.

the fore mentioned light and its housing is not limited to size, shape, construction material, nor is it limited to number of LED's, power output, or brightness.

the fore mentioned eyeglasses, that are optional use to the hunter, are worn over the eyes to dampen any glare or reflection from the blue ultraviolet light off the ground and groundcover which can consist of dirt, rocks, leaves, pine straw, sticks, tree limbs, logs, plants, bushes, etc.

the fore mentioned kit contains the minimum of (i) one battery powered blue LED ultraviolet flashlight not limited to style and (ii) one pair of eyeglasses with amber colored lenses. the fore mentioned blue ultraviolet LED flashlight of any style and the fore mentioned eyeglass accessory with amber colored lenses of the present invention can be marketed together or separate.

while the present invention has been described in detail, it will be apparent to those of ordinary skill in the art that changes and modifications can be made without departing from the scope thereof.

I claim:

1. a method for enhancing the ability of a game hunter to track the blood trail of a wounded game animal at night or in low light conditions by shining and illuminating the ground area of suspected blood with a portable electric ultraviolet light; whereby said blood will absorb the ultraviolet light and darken, and be recognized by the hunter as to the presence of said blood assisting the game hunter in the tracking and locating the wounded game animal; and a kit comprising of (i) a portable electric powered ultraviolet light and (ii) eyeglasses with colored lenses to dampen the glare and reflection of the emitted light.

2. the portable electric powered ultraviolet light as defined in claim 1, wherein the light is 1 (one) or more blue light emitting diode(s) (LED's) that emit ultraviolet light in the electromagnetic wavelength range of 435 to 500 nanometers.

3. the portable electric powered ultraviolet light as defined in claim 1, wherein the light can be a traditional white bulb light or white LED flashlight with a blue lens.

4. the portable electric powered ultraviolet light as defined in claim 1, wherein the electric power is direct current (d.c.) batteries.

5. the portable electric powered ultraviolet light as defined in claim 1, wherein the light housing is not limited to size, shape, construction material, nor is it limited to number of LED's, power output, or brightness.

6. the eyeglasses with colored lenses as defined in claim 1, wherein the lenses to dampen the glare and reflection are amber.

7. the eyeglasses with colored lenses as defined in claim 1, wherein the eyeglasses are not necessarily needed for the method of present invention, but are an accessory to aid with light reflection and glare.

8. the portable electric ultraviolet light and eyeglasses with colored lenses as defined in claim 1, wherein the light and eyeglasses can be marketed together or separate.
